(19) United States
(12) Patent Application Publication
(10) Pub. No.: US 2026/0287010 A1
(43) Pub. Date: Sep. 24, 2026

(54) THRUST FOIL BEARING

(71) Applicant: IHI Corporation, Tokyo (JP)

(72) Inventor: Akihisa FURUNO, Tokyo (JP)

(73) Assignee: IHI Corporation, Tokyo (JP)

(21) Appl. No.: 19/683,883

(22) Filed: May 21, 2026

Related U.S. Application Data
(63) Continuation of application No. PCT/JP2025/004762, filed on Feb. 13, 2025.

(30) Foreign Application Priority Data
Feb. 16, 2024 (JP) 2024-021852

(51) Int. Cl. F16C 17/04

(52) U.S. Cl. CPC F16C 17/042; F16C 2360/44

(57) ABSTRACT

A thrust foil bearing includes: a base plate orthogonal to a rotation center axis; a back foil attached to the base plate and including back foil pieces arranged in a circumferential direction of the rotation center axis assumed on the base plate; and a top foil including top foil pieces arranged in the circumferential direction and covering the back foil pieces. Each back foil piece includes: a strip portion extending from an inner peripheral side to an outer peripheral side of the back foil; and a bump portion extending from a base end portion as a fixed end connected to the strip portion to a tip end portion as a free end, and including a curved portion that protrudes toward the top foil between the base end portion and the tip end portion.

### CROSS REFERENCE TO RELATED APPLICATIONS

This application is a continuation application of International Application No. PCT/JP2025/004762, now WO 2025/173738 A1, filed on February 13, 2025, which claims priority to Japanese Patent Application No. 2024-021852, filed on February 16, 2024, the entire contents of which are incorporated by reference herein.

### TECHNICAL FIELD

The present disclosure relates to a thrust foil bearing.

### BACKGROUND

A thrust foil bearing is a type of fluid bearing that supports a rotor in a non-contact manner by forming a fluid film between the thrust foil bearing and the rotor. The rotor is movably provided along its axial direction, and moves minutely due to vibrations, impacts, and the like.

Regardless of such minute movements of the rotor, the thrust foil bearing needs to maintain the formation of the fluid film. For this purpose, the thrust foil bearing includes thin metal sheets inclined with respect to the rotor. The thin metal sheets are provided to be deflectable in the axial direction. The thin metal sheets form, together with the rotor, a wedge-shaped fluid passage for generating and increasing internal pressure. Patent Literature 1 (JP 2020-037975 A) discloses a thrust foil bearing comprising top foil pieces as the aforementioned thin metal sheets and bump foil pieces that elastically support the top foil pieces.

### SUMMARY

The bump foil pieces of Patent Literature 1 are formed of corrugated sheets in which ridges and valleys are continuous. The corrugated sheets are formed by press forming using a die. On the other hand, the thickness of the fluid film formed by the thrust foil bearing is extremely thin, at most a few micrometers. Therefore, high dimensional accuracy is required for the corrugated sheets during forming. Thus, when forming the corrugated sheet by press forming, one ridge-and-valley pair at a time is formed with a die to suppress distortion in the shape of the corrugated sheet. Due to this process, the manufacture of corrugated sheets takes time and becomes a factor in increasing manufacturing costs.

The present disclosure has been made in view of the above circumstances, and an object thereof is to provide a thrust foil bearing including a back foil capable of suppressing shape distortion while reducing the number of manufacturing steps.

A thrust foil bearing according to one aspect of the present disclosure includes: a base plate orthogonal to a rotation center axis; a back foil placed on the base plate and including back foil pieces arranged in a circumferential direction of the rotation center axis; and a top foil including top foil pieces arranged in the circumferential direction and covering the back foil pieces, wherein each of the back foil pieces includes: a strip portion extending from an inner peripheral side to an outer peripheral side of the back foil; and a bump portion extending from a base end portion as a fixed end connected to the strip portion to a tip end portion as a free end, and including a curved portion that is elastically deformable to protrude toward the top foil between the base end portion and the tip end portion.

The bump portion may be connected to only one of a first-side edge portion and a second-side edge portion of the strip portion in a width direction of the strip portion. The bump portion may be divided into bump pieces arranged in an extending direction of the strip portion. The back foil may include an annular first connecting portion located radially outward of the back foil pieces and connected to the strip portion of each of the back foil pieces. The back foil may include an annular second connecting portion located radially inward of the back foil pieces and connected to the strip portion of each of the back foil pieces.

According to the present disclosure, it is possible to provide a thrust foil bearing comprising a back foil capable of suppressing shape distortion while reducing the number of manufacturing steps.

### BRIEF DESCRIPTION OF DRAWINGS

FIG. 1 is a side view of an example of a turbomachine to which the thrust foil bearing according to an embodiment of the present disclosure is applied.

FIG. 2 is a side view of the thrust foil bearing according to the embodiment.

FIG. 3 is a front view of the thrust foil bearing according to the embodiment.

FIG. 4A is a front view of the top foil according to the embodiment.

FIG. 4B is a front view of the back foil according to the embodiment.

FIG. 4C is a front view of the back foil piece according to the embodiment.

FIG. 4D is a side view showing a state in which the top foil piece and the back foil piece are attached to the base plate.

FIG. 5A is a diagram for explaining the press forming of the back foil piece in a comparative example.

FIG. 5B is a diagram for explaining the press forming of the back foil piece according to the embodiment.

FIG. 6A is a perspective view of the bump portion according to a modification of the embodiment.

FIG. 6B is a perspective view of the bump portion according to a modification of the embodiment.

FIG. 6C is a perspective view of the bump portion according to a modification of the embodiment.

FIG. 6D is a perspective view of the bump portion according to a modification of the embodiment.

FIG. 6E is a perspective view of the bump portion according to a modification of the embodiment.

FIG. 6F is a front view of the bump portion according to a modification of the embodiment.

FIG. 6G is a front view of the bump portion according to a modification of the embodiment.

FIG. 7 is a front view of the back foil according to a modification of the embodiment.

### DESCRIPTION OF EMBODIMENTS

Some embodiments of the present disclosure will be described below. In the drawings, common portions are denoted by the same reference numerals, and redundant descriptions are omitted. For convenience of explanation, an axial direction Z, a circumferential direction CD, a rotational direction TD, and a radial direction RD are defined.

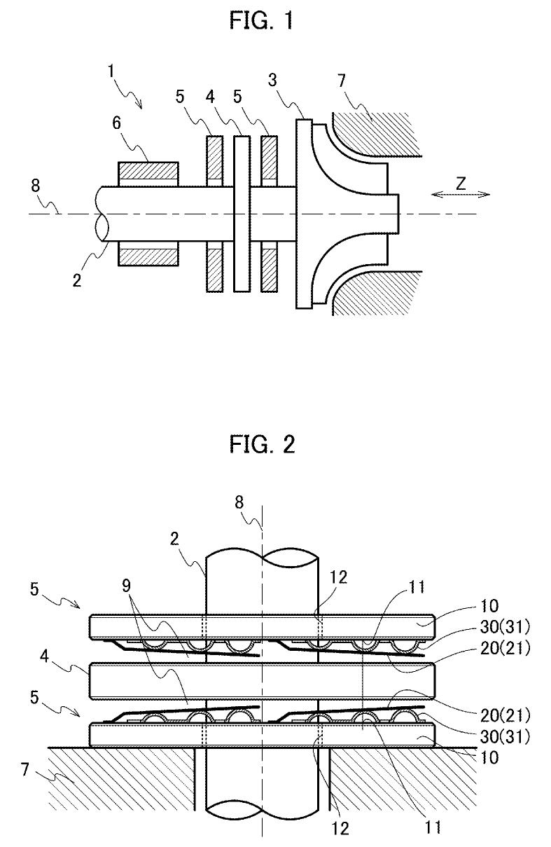

The axial direction Z is the direction in which the rotation center axis 8 (see FIG. 1) extends. The rotation center axis 8 is, for example, the center axis of the shaft 2 or the thrust collar 4, which are rotating bodies, and is a reference axis for defining the positions of the respective components of the thrust foil bearing 5 according to the present embodiment. The circumferential direction CD is the circumferential direction centered on the rotation center axis 8. The rotational direction TD is the rotational direction of the shaft 2, and corresponds to one direction of the circumferential direction CD. The radial direction RD is a direction that originates from the rotation center axis 8 and extends on a plane orthogonal to the rotation center axis 8.

First, an overview of the thrust foil bearing 5 according to the present embodiment will be described. FIG. 1 is a side view of an example of a turbomachine 1 to which the thrust foil bearing 5 according to the present embodiment is applied. As shown in FIG. 1, the turbomachine 1 comprises a shaft 2, an impeller 3, a thrust collar 4, a pair of thrust foil bearings 5, a radial foil bearing 6, and a housing 7 that accommodates these components.

The shaft 2 is rotatably supported by the radial foil bearing 6. The impeller 3 is attached to an end of the shaft 2. The impeller 3 is accommodated in the housing 7 with a tip clearance formed between the impeller 3 and the housing 7. The thrust collar 4 is a disk having a predetermined thickness in the axial direction Z, and is fixed to the shaft 2. The thrust collar 4 is sandwiched between the pair of thrust foil bearings 5. This limits the range of movement of the thrust collar 4 along the axial direction Z.

When the thrust collar 4 is stopped, the thrust collar 4 is placed in a state where it can contact the top foil pieces 21. When the thrust collar 4 starts to rotate, the thrust collar 4 rotates while intermittently or continuously rubbing against the top foil pieces 21. At this time, the rotation of the thrust collar 4 causes fluid to flow into the wedge-shaped fluid passages formed between them, thereby increasing the pressure within the passages. Then, as the rotational speed of the thrust collar 4 increases and the pressure further rises, the top foil 20 deflects toward the back foil 30, and the thrust collar 4 separates from the top foil 20. As a result, a fluid film is formed between the thrust collar 4 and the top foil pieces 21, and the thrust collar 4 starts to rotate in a non-contact manner with respect to the top foil pieces 21.

The back foil pieces 31 are provided between the top foil pieces 21 and the base plate 10, and are configured as elastic members that support the top foil pieces 21. When the pressure within the fluid passage fluctuates due to the thrust force of the thrust collar 4, the deflection of the top foil pieces 21 changes according to the changed pressure. The back foil pieces 31 support the top foil pieces 21 so that the top foil pieces 21 do not deflect excessively. This maintains an appropriate gap between the top foil pieces 21 and the thrust collar 4, and enables the thrust collar 4 to be supported in a non-contact manner.

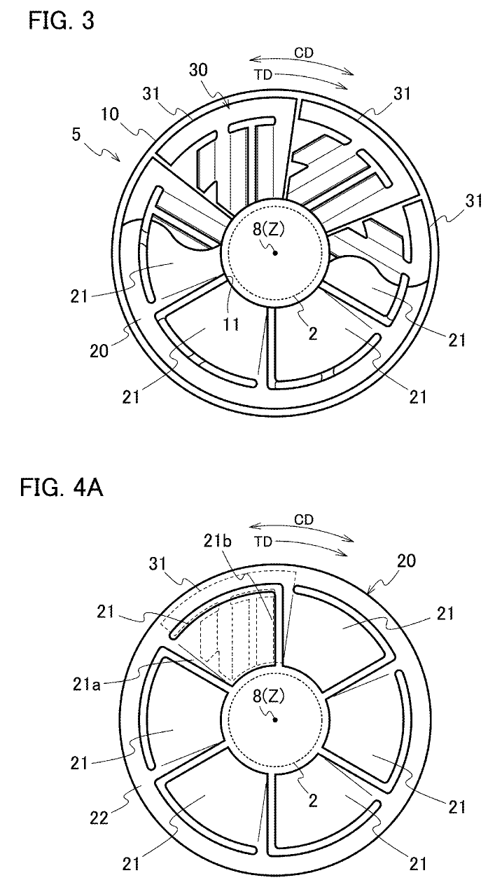

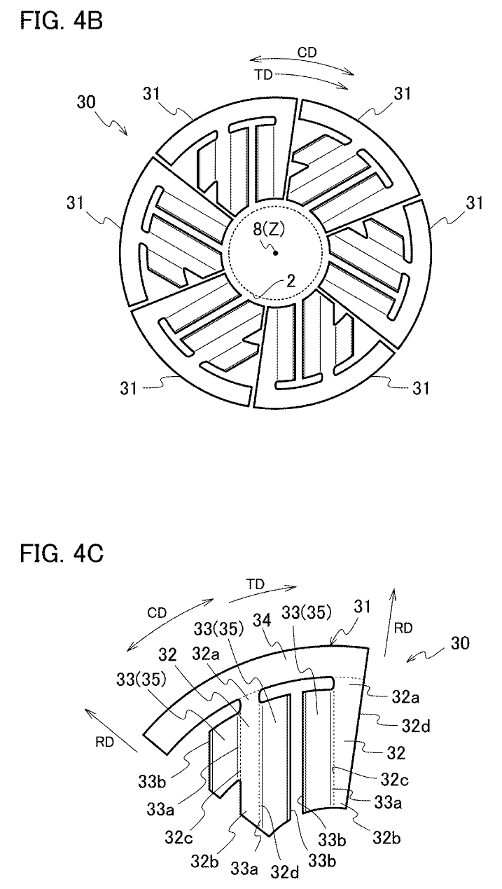

Next, the configuration of the thrust foil bearing 5 will be described. FIG. 2 is a side view of the thrust foil bearing 5 according to the present embodiment. FIG. 3 is a front view of the thrust foil bearing 5 according to the present embodiment. FIG. 3 shows the thrust foil bearing 5 with a portion of the top foil 20 omitted. As shown in these figures, the thrust foil bearing 5 comprises a base plate 10, a top foil 20, and a back foil 30.

The base plate 10 is a flat metal plate orthogonal to the rotation center axis 8, and has a predetermined thickness (for example, several millimeters). The base plate 10 is fixed to, for example, the housing 7. The outer shape of the base plate 10 is not limited to the circular shape shown in FIG. 3, and may be, for example, rectangular. The base plate 10 has a flat surface 11 facing the thrust collar 4. An insertion hole 12 is formed in the flat surface 11. The insertion hole 12 is formed centered on the rotation center axis 8 and penetrates the base plate 10. The shaft 2 is inserted through the insertion hole 12.

It should be noted that, depending on the form in which the thrust foil bearing 5 is applied, there may be cases where the shaft does not penetrate the thrust foil bearing 5. In this case, the thrust collar is fixed to the end of the shaft, while the insertion hole 12 is not formed. Also, the position of the rotation center axis of the shaft is defined on the base plate 10, and the relative positions of the top foil 20 and the back foil 30 with respect to the base plate 10 are defined based on the position of this rotation center axis.

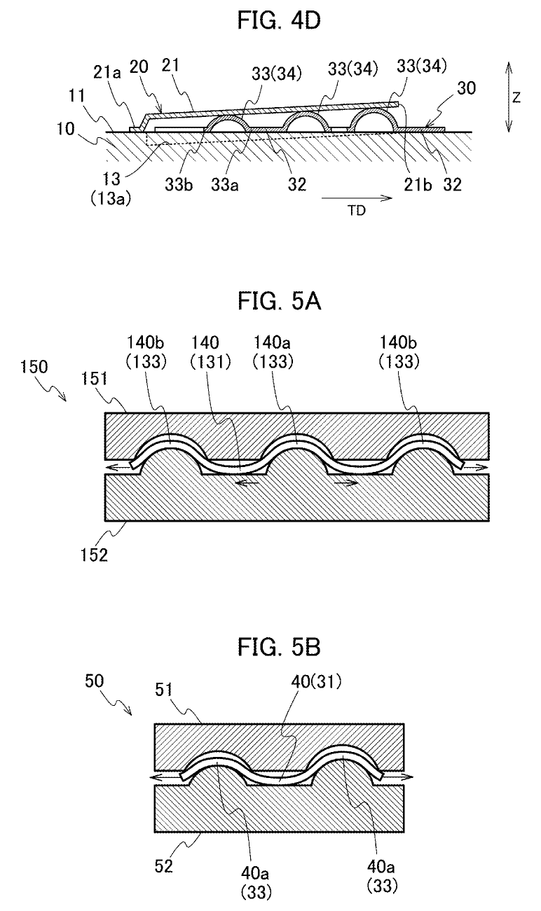

FIG. 4A is a front view of the top foil 20. The top foil 20 is formed of a flexible thin metal sheet. The top foil 20 includes top foil pieces 21 and an annular connecting portion 22, and is placed on the flat surface 11 of the base plate 10 or on the back foil 30 placed on the flat surface 11.

The top foil pieces 21 of the present embodiment are arranged at equal angular intervals along the circumferential direction CD. For example, as shown in FIG. 4A, the top foil pieces 21 are arranged at every 60 degrees around the rotation center axis 8. Each top foil piece 21 has a substantially fan-shaped form with the apex side cut off in an arc, and covers the back foil pieces 31 (at least the bump portions 33 described below) of the back foil 30 (see FIG. 3).

The top foil piece 21 of the present embodiment has an edge portion 21a located on the rear side in the rotational direction TD and extending in the radial direction, and an edge portion 21b located on the front side in the rotational direction TD and extending in the radial direction. The edge portion 21a is provided as a fixed end of the top foil piece 21, while the edge portion 21b is provided as a free end of the top foil piece 21. Further, the top foil piece 21 is inclined at a predetermined inclination angle such that it moves away from the base plate 10 in the direction from the edge portion 21a toward the edge portion 21b.

The top foil 20 includes a connecting portion 22 provided radially outward of the top foil pieces 21 and supporting the top foil pieces 21. The connecting portion 22 is formed in an annular shape and is connected to the edge portion 21a of each top foil piece 21. By fixing the connecting portion 22 to the base plate 10, the edge portion 21a is stably positioned on the flat surface 11.

Each top foil piece 21 forms a wedge-shaped fluid passage 9 (see FIG. 2) together with the thrust collar 4. When the rotating thrust collar 4 approaches the top foil 20, the pressure within the fluid passage 9 increases. This pressure increase raises the pressing force of the top foil piece 21 on the bump portion 33 of the back foil piece 31. The bump portion 33 is elastically deformed from its initial state by this increased pressing force, and as a result, the inclination angle of the top foil piece 21 decreases, maintaining the gap between the thrust collar 4 and the top foil 20.

FIG. 4B is a front view of the back foil 30. FIG. 4C is a front view of the back foil piece 31. FIG. 4D is a side view showing a state in which the top foil piece 21 and the back foil piece 31 are attached to the base plate 10. Like the top foil 20, the back foil 30 is also formed of a flexible thin metal sheet. The back foil 30 includes back foil pieces 31 arranged at intervals in the circumferential direction CD.

The back foil pieces 31 are arranged at equal angular intervals along the circumferential direction CD. For example, as shown in FIG. 4B, the back foil pieces 31 are arranged at every 60 degrees around the rotation center axis 8. Each back foil piece 31 has a substantially fan-shaped outer profile with the apex side cut off in an arc. As shown in FIG. 4C, the back foil piece 31 includes strip portions 32, at least one bump portion 33 connected to each strip portion 32, and a connecting portion 34.

The connecting portion 34 is located radially outward of the strip portions 32 and the bump portions 33, and connects the strip portions 32. For example, as shown in FIG. 4C, the connecting portion 34 is formed in an arc shape having a predetermined width in the radial direction and is connected to an end portion of each strip portion 32.

The strip portions 32 are provided at intervals in the circumferential direction CD and extend parallel to the flat surface 11 of the base plate 10. Each strip portion 32 extends from the inner peripheral side to the outer peripheral side of the back foil 30. For example, as shown in FIG. 4C, the extending direction may be parallel to one (i.e., at a specific azimuthal angle) radial direction RD. Alternatively, the extending direction of the strip portions 32 may be the radial direction RD at different azimuthal angles.

Each strip portion 32 includes an end portion 32a connected to the connecting portion 34, and an end portion 32b located radially inward of the end portion 32a. The strip portion 32 further includes a first-side edge portion 32c in the width direction of the strip portion 32, and a second-side edge portion 32d in the width direction of the strip portion 32. The width direction referred to here is a direction substantially orthogonal to the extending direction (longitudinal direction) of the strip portion 32, and is, for example, the circumferential direction CD.

The bump portion 33 has a width shorter than the total length of the strip portion 32 along the radial direction RD. The bump portion 33 extends from a base end portion 33a as a fixed end connected to the strip portion 32 to a tip end portion 33b as a free end. Furthermore, the bump portion 33 includes an elastically deformable curved portion 35 between the base end portion 33a and the tip end portion 33b. That is, the bump portion 33, in a cantilevered state with respect to the strip portion 32, extends from the base end portion 33a in a predetermined direction (for example, the circumferential direction CD), via the curved portion 35, to the tip end portion 33b.

As described above, the bump portion 33 is cantilevered by the strip portion 32. Therefore, when only one bump portion 33 is provided for one strip portion 32, the base end portion 33a of the bump portion 33 is connected to either the edge portion 32c or the edge portion 32d of the strip portion 32. When two bump portions 33 are provided for one strip portion 32, the base end portion 33a of one of the two bump portions 33 is connected to the edge portion 32c of the strip portion 32, and the base end portion 33a of the other of the two bump portions 33 is connected to the edge portion 32d of the strip portion 32.

The curved portion 35 extends from the base end portion 33a to the tip end portion 33b to protrude toward the top foil piece 21. That is, the curved portion 35 is curved in an arch shape to protrude toward the top foil piece 21. By being formed in an arch shape, the curved portion 35 can be elastically deformed, and the bump portion 33 can elastically support the top foil piece 21 and elastically deform in response to pressing force transmitted via the top foil piece 21.

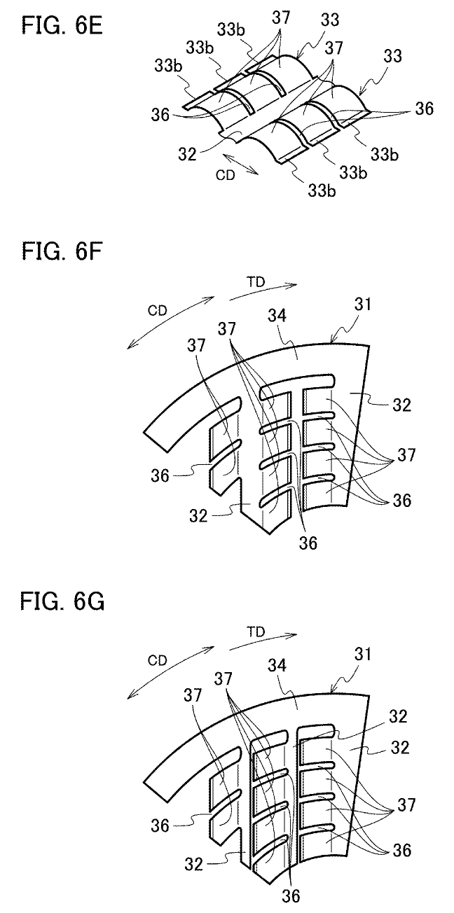

The height of the curved portion 35 along the axial direction Z is set according to the inclination angle set for the top foil piece 21. Specifically, as shown in FIGS. 4D and 6B, among the curved portions 35 adjacent in the circumferential direction CD, the height is set to be greater for those positioned further forward in the rotational direction TD. The heights of the curved portions 35 adjacent in the circumferential direction CD may be the same (see FIG. 6B). In this case, for example, as indicated by the dotted line in FIG. 4D, a recess 13 is formed in the flat surface 11. The bottom surface 13a of the recess 13 is inclined at the same inclination angle as the inclination angle of the top foil piece 21 after attachment, and the bump portions 33 are installed on this bottom surface 13a.

The tip end portion 33b of the bump portion 33 is not connected to any other member of the back foil 30, including the strip portion 32, and is positioned to be contactable with the base plate 10. When the bump portion 33 is pressed toward the base plate 10, the tip end portion 33b slides on the base plate 10 in a direction away from the strip portion 32. That is, the tip end portion 33b functions as a leg portion of the bump portion 33 that prevents excessive localized bending near only the base end portion 33a and promotes elastic deformation of the curved portion 35.

As described above, the back foil 30 is formed by press forming a thin metal sheet using a die 50. The bump portion 33 and the strip portion 32 are formed integrally in a single operation by this forming process.

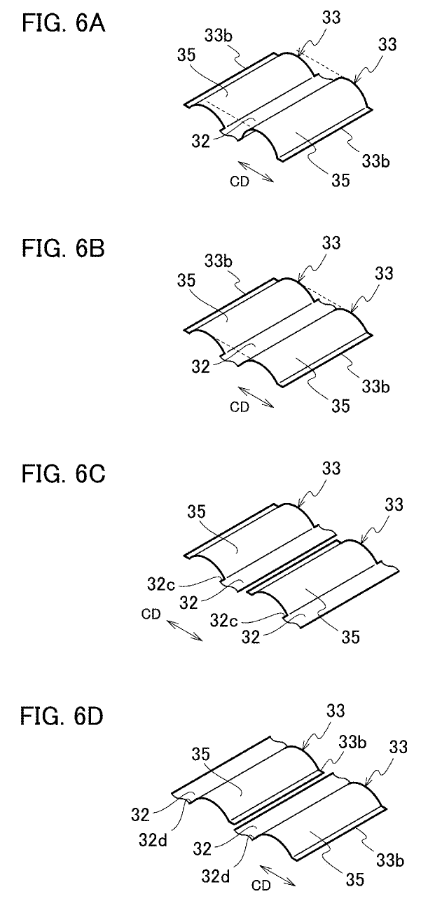

FIG. 5A is a diagram for explaining the press forming of the back foil piece 131 in a comparative example. FIG. 5B is a diagram for explaining the press forming of the back foil piece 31 according to the present embodiment. As shown in FIG. 5A, the comparative example assumes a case in which three bump portions 133 are formed from a thin metal sheet 140 using a die 150. For convenience of explanation, the portion of the thin metal sheet 140 where the central bump portion 133 is formed is denoted by 140a, and the portions on either side thereof where the bump portions 133 are formed are denoted by 140b.

When sandwiching the thin metal sheet 140 between the upper die 151 and the lower die 152, the upper die 151 and the lower die 152 contact the thin metal sheet 140 at locations. If friction becomes excessively strong at these contact points, the movement and elongation of the thin metal sheet 140 will be restricted, and internal stress will remain, making the shape prone to distortion. For example, as shown in FIG. 5A, when three bump portions 133 are formed simultaneously, the two portions 140b, 140b move away from each other, so the portion 140a of the thin metal sheet 140 therebetween is pulled excessively, making it more prone to retaining residual internal stress that tends to cause distortion and the like.

On the other hand, the bump portion 33 according to the present embodiment is formed on only one side or on each of both sides of one strip portion 32. That is, the maximum number of bump portions 33 provided for one strip portion 32 is two.

Therefore, in a cross-sectional view taken along a cross section that includes one strip portion 32 and a bump portion 33 formed on one side thereof, and that is perpendicular to the support surface on which the back foil piece 131 is arranged, only a single arch (ridge) is formed as the bump portion 33 on one side of the strip portion 32. Here, the term "arch" refers to a structure including a bottom portion closest to the support surface and a peak provided between the bottom portion and the strip portion 32. The peak herein is not limited to a point as in the present embodiment, and may have a width. In the arch, the bottom portion can abut against the support surface, while the portion between the bottom portion and the strip portion 32 is not configured to abut against the support surface.

In the present embodiment, the bottom portion is a region having a width in cross-sectional view, but may be a point in cross-sectional view. Note that in the present embodiment, the strip portion 32 is also configured to be able to abut against the support surface, but a configuration in which there is a gap between the strip portion 32 and the support surface is also acceptable. Further, in the present embodiment, the tip end portion 33b is included in the bottom portion. However, the expression "only a single arch is formed" also includes those in which the tip end portion 33b is formed in a remaining portion that extends from the bottom portion in a direction away from the strip portion 32 without forming an arch (that is, this also includes cases in which the tip end portion 33b is separated from the support surface).

As shown in FIG. 5B, when sandwiching the thin metal sheet 40, which is the base material of the bump portion 33 and the strip portion 32, between the upper die 51 and the lower die 52, the upper die 51 and the lower die 52 contact the thin metal sheet 40 at locations. Similar to the comparative example, friction increases locally at these contact points.

However, in the present embodiment, the number of bump portions 33 formed using the die 50 for one strip portion 32 is at most two, and the tip end portion 33b is formed as a free end for each bump portion 33. Therefore, when the thin metal sheet 40 is sandwiched between the upper die 51 and the lower die 52, the portion 40a of the thin metal sheet 40 that will become the bump portion 33 is allowed to slide and elongate in the leftward or rightward direction in FIG. 5. In other words, this portion 40a avoids being constrained by excessive friction. As a result, the bump portion 33 and the strip portion 32 can be formed into the desired shape without distortion. Furthermore, since residual stress is reduced, it is also possible to suppress the occurrence of distortion in the bump portion 33 and the strip portion 32 after formation.

In the present embodiment, one back foil piece 31 is provided with strip portions 32. That is, one back foil piece 31 is provided with bump portions 33. However, as shown in FIG. 5B, since one end of each bump portion 33 is formed as a free end, the occurrence of distortion can be suppressed. That is, bump portions 33 can be formed in a single forming operation, thereby reducing the number of manufacturing steps compared to the case where corrugated sheets in which ridges and valleys are continuously alternating are formed by repeating the positioning and forming of the thin metal sheet 40.

Next, modifications of the present embodiment will be described. FIGS. 6A to 6G are diagrams for explaining the bump portions 33 according to modifications of the present embodiment. FIGS. 6A to 6E are perspective views of the bump portions 33 according to the modifications. FIGS. 6F and 6G are front views of the bump portions 33 according to the modifications. As shown in FIGS. 6A and 6B, the heights of the bump portions 33 may be the same or may differ from each other. This is as described above.

Furthermore, the bump portion 33 may be connected to only one of the first-side edge portion 32c and the second-side edge portion 32d of the strip portion 32 in the width direction of the strip portion 32. For example, as shown in FIG. 6C, the bump portions 33 may each extend in a predetermined direction (for example, the circumferential direction CD) from only the edge portion 32c of the strip portion 32 corresponding to each bump portion 33. Alternatively, as shown in FIG. 6D, the bump portions 33 may each extend in a predetermined direction (for example, the circumferential direction CD) from only the edge portion 32d of the strip portion 32 corresponding to each bump portion 33. By standardizing the relative position of the bump portions 33 with respect to each strip portion 32, the distribution of the positions of the bump portions 33 can be made more uniform, and the positional bias of the contact points with the top foil pieces 21 can be reduced.

Furthermore, the bump portion 33 may be divided into bump pieces 37 arranged in the extending direction of the strip portion 32 by at least one slit 36. That is, as shown in FIG. 6E, the slit 36 extends in a predetermined direction (for example, the circumferential direction CD) within the bump portion 33. Therefore, the bump pieces 37 are arranged in the extending direction of the strip portion 32. The slit 36 can be applied to any of the forms described above. As one example thereof, FIG. 6F shows an example in which slits 36 are formed in the back foil piece 31 shown in FIG. 4C. Also, FIG. 6G shows an example in which the back foil piece 31 shown in FIG. 4C is changed to the form shown in FIG. 6C, with slits 36 further formed therein. By dividing the bump portion 33, when a pressure distribution occurs in the wedge-shaped fluid passage, the followability can be ensured because each bump portion 33 can move independently.

The dimensions of the bump portions 33 (bump pieces 37) may differ from each other. The dimensions referred to here are, for example, the height, width, length from the base end portion 33a to the tip end portion 33b, the radius of curvature of the curved portion 35, and the dimensions defining the outer profile as viewed from the axial direction Z. By individually varying the dimensions of the bump portions 33 (bump pieces 37), the spatial distribution of the spring constant in the back foil piece 31 can be manipulated.

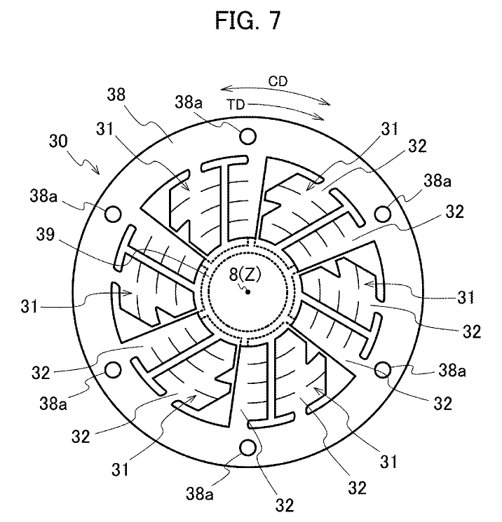

FIG. 7 is a front view of the back foil 30 according to a modification of the present embodiment. As shown in FIG. 7, the back foil 30 may include a connecting portion (first connecting portion) 38. The connecting portion 38 is located radially outward of the back foil pieces 31. The connecting portion 38 is formed in an annular shape to surround the back foil pieces 31. The connecting portion 38 is also connected to the strip portion 32 of each back foil piece 31 to support them. By connecting to the connecting portion 38, the relative positions of the back foil pieces 31 are determined. This facilitates the positioning of the back foil pieces 31 with respect to the base plate 10. Also, through-holes 38a may be provided at locations in the connecting portion 38. In this case, similar through-holes (not shown) may also be provided in the top foil 20, and the back foil 30 and the top foil 20 may be fixed to the base plate 10 by screw fastening or the like using these through-holes 38a. This makes it possible to fix the back foil pieces 31 together.

The back foil 30 may further include a connecting portion (second connecting portion) 39, indicated by a dotted line in FIG. 7. The connecting portion 39 is located radially inward of the back foil pieces 31. When the insertion hole 12 is formed in the base plate 10, the connecting portion 39 is located radially inward of the back foil pieces 31 and radially outward of the insertion hole 12. The connecting portion 39 is connected to at least one strip portion 32 of each back foil piece 31. The connecting portion 39 can suppress undesirable deformation (for example, warping toward the thrust collar) of the inner peripheral portion of the top foil 20.

The present disclosure is not limited to the above-described embodiments, and is indicated by the description of the claims, and further includes all modifications within the scope equivalent in meaning and range to the description of the claims.

What is claimed is:

1. A thrust foil bearing comprising:
a base plate orthogonal to a rotation center axis;
a back foil placed on the base plate and including back foil pieces arranged in a circumferential direction of the rotation center axis; and
a top foil including top foil pieces arranged in the circumferential direction and covering the back foil pieces, wherein
each of the back foil pieces includes:
a strip portion extending from an inner peripheral side to an outer peripheral side of the back foil; and
a bump portion extending from a base end portion as a fixed end connected to the strip portion to a tip end portion as a free end, and including a curved portion that is elastically deformable to protrude toward the top foil between the base end portion and the tip end portion.

2. The thrust foil bearing according to claim 1, wherein
the bump portion is connected to only one of a first-side edge portion and a second-side edge portion of the strip portion in a width direction of the strip portion.

3. The thrust foil bearing according to claim 1, wherein
the bump portion is divided into bump pieces arranged in an extending direction of the strip portion.

4. The thrust foil bearing according to claim 2, wherein
the bump portion is divided into bump pieces arranged in an extending direction of the strip portion.

5. The thrust foil bearing according to claim 1, wherein
the back foil includes an annular first connecting portion located radially outward of the back foil pieces and connected to the strip portion of each of the back foil pieces.

6. The thrust foil bearing according to claim 5, wherein
the back foil includes an annular second connecting portion located radially inward of the back foil pieces and connected to the strip portion of each of the back foil pieces.
